(19) United States
(12) Patent Application Publication
(10) Pub. No.: US 2026/0300695 A1
(43) Pub. Date: Oct. 1, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Iori TOKUDA, Tokyo (JP); Yasuhiro MIZUKOSHI, Tokyo (JP)

(73) Assignee: NEC Corporation, Tokyo (JP)

(21) Appl. No.: 19/571,864

(22) Filed: Mar. 19, 2026

(30) Foreign Application Priority Data
Mar. 26, 2025 (JP) 2025-051210

(51) Int. Cl. G06N 3/0475; G06N 3/045

(52) U.S. Cl. CPC G06N 3/0475; G06N 3/045

(57) ABSTRACT

In an information processing device, a first AI processing means performs inference processing using first generative AI selected from a plurality of types of generative AI different in performance. A second AI processing means executes inference processing using second generative AI selected from a plurality of types of generative AI different in performance. Here, the performance includes answer accuracy, response speed, and cost. The first generative AI is selected based on the content of the inference processing performed by the first AI processing means and the performance, and the second generative AI is selected based on the content of the inference processing performed by the second AI processing means and the performance.

### INCORPORATION BY REFERENCE

This application is based upon and claims the benefit of priority from Japanese patent application No. 2025-051210, filed on Mar. 26, 2025, the disclosure of which is incorporated herein in its entirety by reference.

### TECHNICAL FIELD

The present disclosure relates to a system with a combination of a plurality of types of generative AI.

### BACKGROUND ART

Services using generative artificial intelligence (AI) have become widespread. In such a service as described above, because the fee varies depending on the performance and the usage count of the generative AI, efficient operation is required. For example, in Patent Document 1, proposed is an information processing device that can perform efficient operation in a service using generative AI.

Patent Document 1: JP 7506957 B1

### SUMMARY

A system with a combination of a plurality of types of generative AI has problems in a decrease in response speed and an increase in cost. Therefore, it needs to select suitable generative AI for each task in consideration of the performance (answer accuracy and response speed) and cost of the generative AI. The technique in Patent Document 1 aims at improving the operation efficiency by reducing the usage frequency of the generative AI, and the performance of the generative AI provided from each company is not considered.

An object of the present disclosure is to provide an information processing device that enables suppression of a decrease in response speed and an increase in cost while maintaining answer accuracy in a system with a combination of a plurality of types of generative AI.

According to an example aspect of the present invention, there is provided an information processing device, including:
at least one memory configured to store instructions; and
at least one processor configured to execute the instructions to:
perform first inference processing using first generative AI selected from a plurality of types of generative AI different in performance including answer accuracy, response speed, and cost; and
perform second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.

According to another example aspect of the present invention, there is provided an information processing method including:
performing first inference processing using first generative AI selected from a plurality of types of generative AI different in performance including answer accuracy, response speed, and cost; and
performing second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.

According to a further example aspect of the present invention, there is provided a recording medium recording a program for causing a computer to execute processing including:
performing first inference processing using first generative AI selected from a plurality of types of generative AI different in performance including answer accuracy, response speed, and cost; and
performing second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.

According to the present disclosure, provided can be an information processing device that enables suppression of a decrease in response speed and an increase in cost while maintaining answer accuracy in a system with a combination of a plurality of types of generative AI.

### BRIEF DESCRIPTION OF THE DRAWINGS

FIG. 1 illustrates the overall configuration of an inquiry system to which an information processing device according to the present disclosure is applied;

FIG. 2 illustrates the overall configuration of an HS code identification system;

FIG. 3 explanatorily illustrates an HS code;

FIG. 4 is a block diagram illustrating the hardware configuration of the information processing device according to an application example;

FIG. 5 is a block diagram illustrating the functional configuration of the information processing device according to the application example;

FIG. 6 is a flowchart of processing by the information processing device according to the application example;

FIG. 7 illustrates the overall configuration of an inquiry system to which another information processing device according to the present disclosure is applied;

FIG. 8 is a block diagram illustrating the functional configuration of the information processing device according to another application example;

FIG. 9 illustrates the overall configuration of an inquiry system to which another information processing device according to the present disclosure is applied;

FIG. 10 is a block diagram illustrating the functional configuration of the information processing device according to still another application example;

FIG. 11 is a flowchart of processing by the information processing device according to the other application example;

FIG. 12 is a block diagram illustrating the functional configuration of another information processing device according to the present disclosure; and

FIG. 13 is a flowchart of processing by the other information processing device according to the present disclosure.

### EXAMPLE EMBODIMENT

Hereinafter, preferred example embodiments of the present disclosure will be described with reference to the drawings.

### First Example Embodiment

### [Overall Configuration]

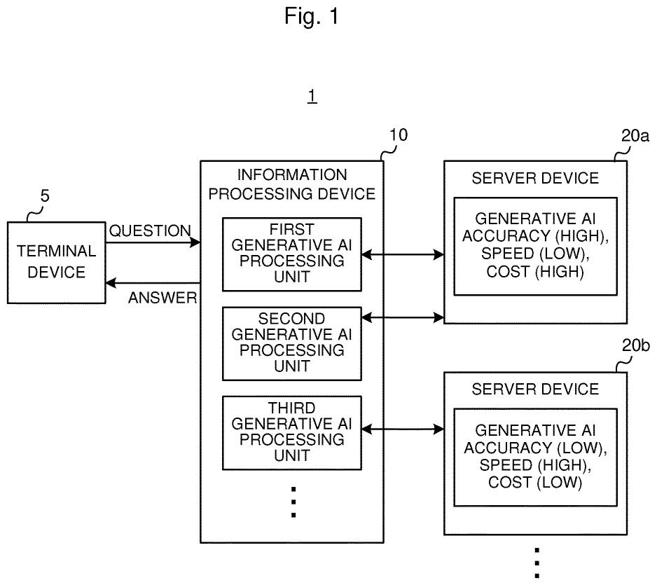

FIG. 1 illustrates the overall configuration of an inquiry system to which an information processing device according to the present disclosure is applied; An inquiry system 1 includes a terminal device 5, an information processing device 10, and a plurality of server devices 20. The server devices 20 are each an external server device that provides a service using generative AI. The server devices 20 are referred to with a suffix added thereto when the individual services are distinguished, and are simply referred to as “server device 20” when not distinguished.

The terminal device 5 is operated by a user and transmits the question input by the user to the information processing device 10. The terminal device 5 includes, for example, a personal computer, a tablet terminal device, and others, and communicates with the information processing device 10 through a network such as the Internet.

The information processing device 10 generates an answer to the question and transmits the answer to the terminal device 5. The information processing device 10 includes a plurality of generative AI processing units. The generative AI processing units each perform inference processing using generative AI provided by such a server device 20 as described above. The generative AI processing units may each perform pieces of inference processing in order or may perform the pieces of inference processing independently. The information processing device 10 includes, for example, a server device and others, and communicates with the terminal device 5 and the server device 20 through a network such as the Internet.

The server device 20 is a server that provides a service using generative AI. Examples of the service using the generative AI include GPT-4 (Generative Pre-trained Transformer 4), GPT-4°, and GPT-4o mini by OpenAI. The types of generative AI provided by the plurality of server devices 20 are different in performance (answer accuracy and response speed) and usage fee (hereinafter, also referred to as “cost”). In FIG. 1, a server device 20a provides generative AI with high accuracy, low speed, and high cost. A server device 20b provides generative AI with low accuracy, high speed, and low cost.

The information processing device 10 of the present example embodiment is characterized in that the generative AI processing units each use a different type of generative AI in accordance with the content of the processing. For example, in a case where high accuracy is required, the generative AI processing units each use generative AI with high accuracy, and in a case where high accuracy is not required, the generative AI processing units each use generative AI with high speed or generative AI with low cost regardless of accuracy. Such a usage enables suppression of a decrease in response speed and an increase in cost while maintaining answer accuracy.

### Application Examples

The application example of a first example embodiment will be described. An inquiry system of the present example embodiment is applicable to an HS code identification system.

### (Overall Configuration)

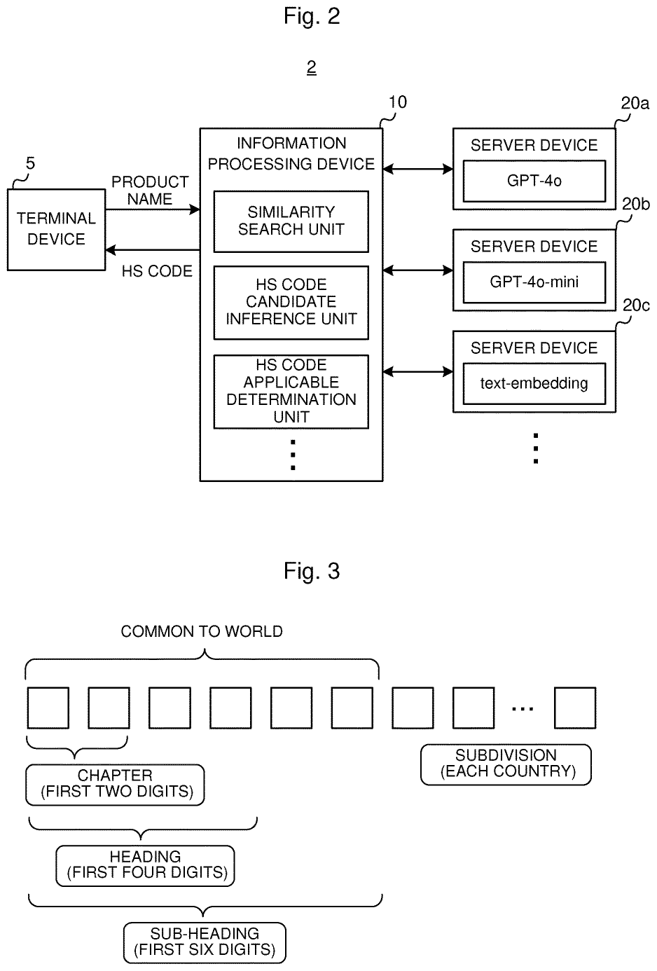

FIG. 2 illustrates the overall configuration of the HS code identification system. An HS code identification system 2 includes a terminal device 5, an information processing device 10, and a plurality of server devices 20.

The terminal device 5 is operated by a user such as a registered customs specialist or a salesperson. In a case where the user desires to know the HS code of a certain product, the user operates the terminal device 5 to transmit the product name to the information processing device 10.

The information processing device 10 infers the HS code for the product name and transmits the inference result to the terminal device 5. The information processing device 10 includes three generative AI processing units of a similarity search unit, an HS code candidate inference unit, and an HS code applicable determination unit. Although the details will be described later, the similarity search unit, the HS code candidate inference unit, and the HS code applicable determination unit perform each piece of processing using generative AI provided by such a server device 20 as described above.

The server device 20 is a server that provides a service using generative AI. In the present application example, a server device 20a provides a GPT-4o, a server device 20b provides a GPT-4o mini, and a server device 20c provides text-embedding all by OpenAI.

### (Description of HS Code)

Next, an HS code will be described. FIG. 3 explanatorily illustrates an HS code. Such HS codes (harmonized system codes) as described above are code numbers defined based on the International Convention on a Uniform System for the Designation and Classification of Goods (Harmonized Commodity Description and Coding System). The HS codes are used for trade target items broadly classified into 21 “sections” and each represents 6 or more digits. The number common to the world is up to six digits, and the numbers after the six digits can be used by adding a freely-selected number of digits by each country. Of the six digits, the first two digits are referred to as a chapter, the first four digits including the chapter are referred to as a heading, and the first six digits including the heading are referred to as a sub-heading. In FIG. 3, an example in which the HS code is represented by a 9-digit number will be described. For example, the first nine digits including the sub-heading are referred to as a subdivision. In the present example embodiment, an example for searching for a 9-digit HS code will be described.

HS codes can be obtained from an export statistical schedule or an import statistical schedule (customs tariff schedule) disclosed on the customs website (https://www.customs.go.jp/). When an HS code is examined, in addition to the statistical schedules described above, notes to the chapters (hereinafter, also referred to as “chapter notes”), explanatory notes to the harmonized tariff schedule, classification rulings, and others can be considered. In the chapter notes, the explanation of chapters is described. In the explanatory notes to the harmonized tariff schedule, the explanation of headings is described. Further, in the explanatory notes to the harmonized tariff schedule, a product name corresponding to a sub-heading in the hierarchy under each heading is described. In the classification rulings, examples of the product name corresponding to the sub-heading are described. The chapter notes, the explanatory notes to the harmonized tariff schedule, and the classification rulings are disclosed on the customs website.

### (Hardware Configuration)

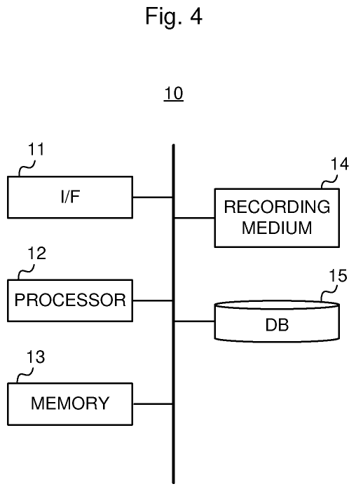

FIG. 4 is a block diagram illustrating the hardware configuration of the information processing device 10 according to the application example. As illustrated in the drawing, the information processing device 10 includes an interface (I/F) 11, a processor 12, a memory 13, a recording medium 14, and a database (DB) 15.

The I/F 11 communicates with the terminal device 5 and the server devices 20 through a network such as the Internet.

The processor 12 is a computer such as a central processing unit (CPU), and executes a program prepared in advance to take overall control of the information processing device 10. The processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination thereof. The processor 12 performs HS code identification processing to be described later.

The memory 13 includes a read only memory (ROM), a random access memory (RAM), and others. The memory 13 is also used as a work memory during performing various types of processing by the processor 12.

The recording medium 14 is a non-volatile and non-transitory recording medium such as a disk-shaped recording medium or a semiconductor memory, and is detachably attachable to the information processing device 10. The recording medium 14 records various programs executed by the processor 12. In order for the information processing device 10 to perform various types of processing, a program recorded in the recording medium 14 is loaded into the memory 13 and is executed by the processor 12.

The DB 15 stores information disclosed by the customs, such as the export statistical schedule, customs tariff schedule, the chapter notes, the explanatory notes to the harmonized tariff schedule, the classification rulings, and others. The information described above is stored in the DB 15 after being converted into a text by an optical character recognition technology or the like, or after being converted into a vector by an embedding model or the like.

In addition to the above constituents, the information processing device 10 may include a display device such as a liquid crystal display and an input device such as a keyboard or a mouse. The display device and the input device are used by an administrator of the information processing device 10 to perform necessary management, for example.

### (Functional Configuration)

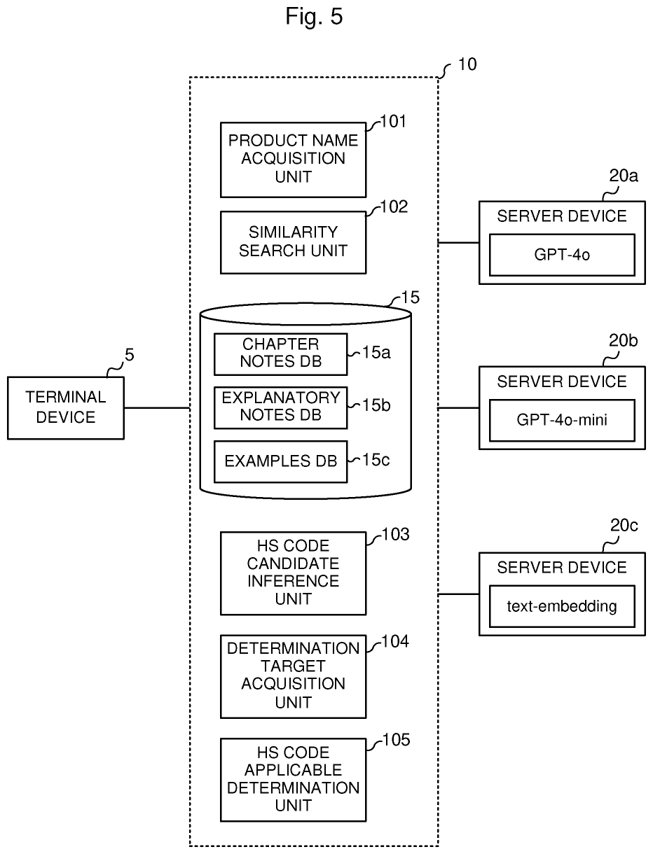

FIG. 5 is a block diagram illustrating the functional configuration of the information processing device 10 according to the application example. The information processing device 10 functionally includes a product name acquisition unit 101, a similarity search unit 102, an HS code candidate inference unit 103, a determination target acquisition unit 104, an HS code applicable determination unit 105, a chapter notes DB 15a, an explanatory notes DB 15b, and an examples DB 15c.

The product name acquisition unit 101, the similarity search unit 102, the HS code candidate inference unit 103, the determination target acquisition unit 104, and the HS code applicable determination unit 105 are included in the processor 12 illustrated in FIG. 4. The chapter notes DB 15a, the explanatory notes DB 15b, and the examples DB 15c are achieved by the DB 15 illustrated in FIG. 4.

A product name is received from the terminal device 5 into the information processing device 10 through the I/F 11. The product name is the name of a product such as “document file”. The product name is input into the product name acquisition unit 101. The product name acquisition unit 101 outputs the product name into the similarity search unit 102, the HS code candidate inference unit 103, and the HS code applicable determination unit 105.

The chapter notes DB 15a, the explanatory notes DB 15b, and the examples DB 15c are vector DBs. The chapter notes DB 15a stores a chapter, chapter notes corresponding to the chapter, and vectorized chapter notes in association with each other. The explanatory notes DB 15b stores a heading, the explanatory notes to the harmonized tariff schedule corresponding to the heading, and vectorized explanatory notes to the harmonized tariff schedule in association with each other. The examples DB 15c stores a sub-heading, classification rulings corresponding to the sub-heading, and vectorized classification rulings in association with each other.

The similarity search unit 102 performs vector search, and acquires, respectively, a “chapter”, a “heading”, and a “sub-heading” relating to the product name from the chapter notes DB 15a, the explanatory notes DB 15b, and the examples DB 15c. Specifically, the similarity search unit 102 uses generative AI provided by the server device 20c and converts the product name (text data) into a vector. Then, the similarity search unit 102 calculates the similarity between the vector of the product name and each vector stored in the chapter notes DB 15a, the explanatory notes DB 15b, and the examples DB 15c, thereby identifying the chapter, heading, or sub-heading relating to the product name. For example, a cosine similarity or a Euclidean distance is used as the similarity between the vectors.

It is assumed that the similarity search unit 102 acquires one or a plurality of chapters and headings relating to product name. Therefore, such a chapter acquired by the similarity search unit 102 is hereinafter also referred to as a “chapter number list”, and such a heading acquired by the similarity search unit 102 is hereinafter also referred to as a “heading number list”. The similarity search unit 102 acquires a sub-heading relating to the product name from the examples DB 15c. The sub-heading acquired by the similarity search unit 102 is also referred to as a “similarity example”. The similarity search unit 102 outputs the chapter number list, the heading number list, and the similarity example to the HS code candidate inference unit 103.

The product name is received from the product name acquisition unit 101 to the HS code candidate inference unit 103, and the chapter number list, the heading number list, and the similarity example are received from the similarity search unit 102 to the HS code candidate inference unit 103.

First, the HS code candidate inference unit 103 extracts a customs tariff schedule based on the chapter number list and the heading number list. The customs tariff schedule is collected for each chapter, and the HS code and the product name represented by the HS code are described in association with each other. The HS code candidate inference unit 103 extracts the customs tariff schedule of the chapter included in the chapter number list and the heading number list from the entirety of the customs tariff schedule.

Next, the HS code candidate inference unit 103 uses the generative AI provided by the server device 20a to infer a candidate of the HS code. Specifically, the HS code candidate inference unit 103 generates a prompt (instruction sentence) to be input into the generative AI. The prompt includes an instruction to output the candidate of the HS code and information necessary for execution of the task (i.e., the product name, the extracted customs tariff schedule, and the similarity example). The HS code candidate inference unit 103 transmits the generated prompt to the server device 20a and receives an answer to the prompt from the server device 20a. The answer includes a plurality of candidates of the HS code for the product name. The HS code candidate inference unit 103 outputs the answer from the server device 20a to the determination target acquisition unit 104. Such a candidate of the HS code as described above is also referred to as an “HS code candidate”.

The determination target acquisition unit 104 generates display data including the plurality of HS code candidates based on the answer from the server device 20a, and transmits the display data to the terminal device 5. In a case where the user desires to determine whether an HS code candidate is suitable, the user operates the terminal device 5 to select an HS code candidate to be determined. The determination target acquisition unit 104 acquires the HS code candidate to be determined and outputs the HS code candidate into the HS code applicable determination unit 105.

The product name is received from the product name acquisition unit 101 into the HS code applicable determination unit 105, and the HS code candidate to be determined is received from the determination target acquisition unit 104 into the HS code applicable determination unit 105.

The HS code applicable determination unit 105 performs applicable determination for determining whether the HS code candidate is suitable. First, the HS code applicable determination unit 105 infers the HS code for the product name in more detail using the generative AI provided by the server device 20b. Specifically, the HS code applicable determination unit 105 generates a prompt for inputting into the generative AI. The prompt includes an instruction to output the HS code with reference to the product name, the HS code candidate to be determined, and various pieces of information (hereinafter, also referred to as “customs website information”) disclosed on the customs website. The customs website information includes, for example, a chapter title, a heading title, the customs tariff schedule, the chapter notes, the explanatory notes to the harmonized tariff schedule, and the classification rulings of the customs tariff schedule. The HS code applicable determination unit 105 transmits the generated prompt to the server device 20b and receives an answer to the prompt from the server device 20b. The answer includes an HS code inferred by the generative AI.

Next, the HS code applicable determination unit 105 determines whether the HS code candidate matches the inferred HS code. In a case where the HS code candidate matches the inferred HS code, the HS code applicable determination unit 105 determines that the HS code candidate is suitable. Otherwise, in a case where the HS code candidate does not match the inferred HS code, the HS code applicable determination unit 105 determines that the HS code candidate is unsuitable. The HS code applicable determination unit 105 transmits the determination result to the terminal device 5. The processing by the HS code applicable determination unit 105 is performed every time the user selects a HS code candidate to be determined.

As described above, in the information processing device 10 according to the application example, the generative AI processing units (the similarity search unit 102, the HS code candidate inference unit 103, and the HS code applicable determination unit 105) use the different types of generative AI. Specifically, the generative AI processing by the HS code candidate inference unit 103 is performed a smaller number of times and with a smaller amount of reference information. On the other hand, the generative AI processing by the HS code applicable determination unit 105 may be repeatedly performed as many times as the number of HS code candidates (i.e., the number of times of performing increases). Therefore, the HS code candidate inference unit 103 uses the generative AI (GPT-4o) with high answer accuracy provided by the server device 20a, and the HS code applicable determination unit 105 uses the generative AI (GPT-4o mini) with high response speed and low cost provided by the server device 20b. In such a manner, the information processing device 10 can achieve improvement in response speed and cost reduction while maintaining answer accuracy.

In the above configuration, the similarity search unit 102, the HS code candidate inference unit 103, and the HS code applicable determination unit 105 are exemplary first AI processing means and second AI processing means. The product name acquisition unit 101 is an exemplary acquisition means. The HS code candidate inference unit 103 and the HS code applicable determination unit 105 are exemplary output means. (Processing Flow)

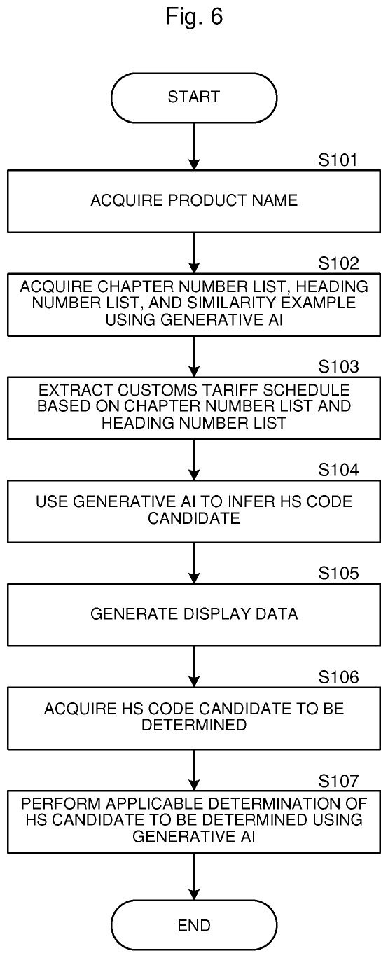

FIG. 6 is a flowchart of HS code identification processing by the information processing device 10 according to the application example. This processing is achieved by the processor 12 illustrated in FIG. 4 executing a program prepared in advance and operating as each constituent illustrated in FIG. 5.

First, a product name is received from the terminal device 5 into the information processing device 10 through the I/F 11. The product name is input into the product name acquisition unit 101 (step S101). The product name acquisition unit 101 outputs the product name into the similarity search unit 102, the HS code candidate inference unit 103, and the HS code applicable determination unit 105.

Next, the similarity search unit 102 performs vector search using the generative AI provided by the server device 20c, and acquires, respectively, the chapter number list, the heading number list, and the similarity example relating to the product name from the chapter notes DB 15a, the explanatory notes DB 15b, and the examples DB 15c (step S102). The similarity search unit 102 outputs the chapter number list, the heading number list, and the similarity example to the HS code candidate inference unit 103.

Next, the HS code candidate inference unit 103 extracts a customs tariff schedule based on the chapter number list and the heading number list (step S103). Next, the HS code candidate inference unit 103 uses the generative AI provided by the server device 20a to infer an HS code candidate (step S104). Specifically, the HS code candidate inference unit 103 generates a prompt including an instruction to output an HS code candidate and information (i.e., the product name, the extracted customs tariff schedule, and the similarity example) necessary for performing the task. The HS code candidate inference unit 103 transmits the generated prompt to the server device 20a and receives an answer to the prompt (i.e., HS code candidate) from the server device 20a. The HS code candidate inference unit 103 outputs the answer from the server device 20a to the determination target acquisition unit 104.

The determination target acquisition unit 104 generates display data including a plurality of HS code candidates, and transmits the display data to the terminal device 5 (step S105). In a case where the user desires to determine whether an HS code candidate is suitable, the user operates the terminal device 5 to select an HS code candidate to be determined. The determination target acquisition unit 104 acquires the HS code candidate to be determined (step S106) and outputs the HS code candidate to the HS code applicable determination unit 105.

Next, The HS code applicable determination unit 105 performs applicable determination whether the HS code candidate is suitable, using the generative AI provided by the server device 20b (step S107). Specifically, the HS code applicable determination unit 105 infers an HS code for the product name in more detail using the generative AI provided by the server device 20b, and determines whether the HS code candidate matches the inferred HS code. The HS code applicable determination unit 105 transmits the determination result to the terminal device 5. Then, the processing ends.

According to the first example embodiment, in the system with the combination of the plurality of types of generative AI, a decrease in response speed and an increase in cost can be suppressed while maintaining answer accuracy.

### Second Example Embodiment

Next, a second example embodiment will be described. In the second example embodiment, differences from the first example embodiment will be described, and thus the description of similar parts will not be given. Further, in the second example embodiment, the same constituents as those in the first example embodiment will be described with the same reference signs.

### [Overall Configuration]

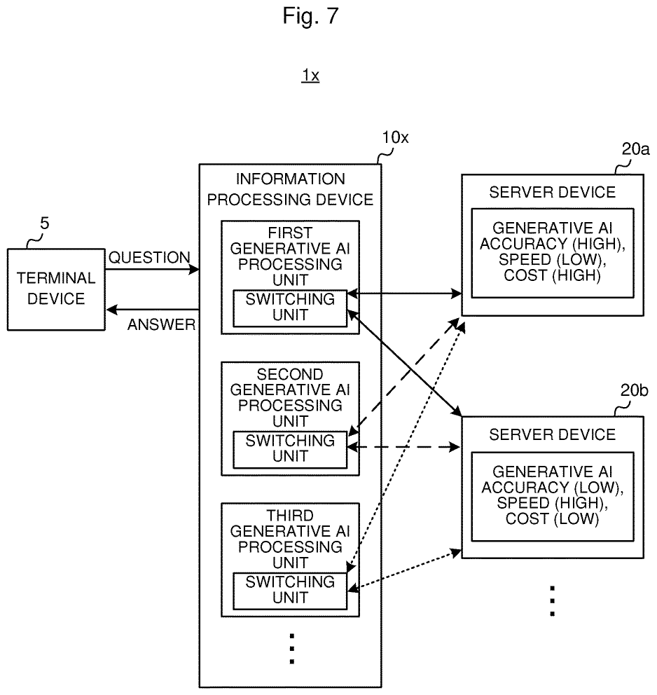

FIG. 7 illustrates the overall configuration of an inquiry system to which an information processing device according to the second example embodiment is applied. An inquiry system 1x includes a terminal device 5, an information processing device 10x, and a plurality of server devices 20.

The information processing device 10x is based on the information processing device 10 according to the first example embodiment, and generative AI processing units each include a switching unit. The switching unit makes a switch between types of generative AI used by the generative AI processing unit. For example, in the operation phase of the inquiry system, in a case where the cost increases, the switching unit switches from the type of generative AI being used to a type of generative AI with low cost. In a case where the answer accuracy has decreased, the switching unit switches from the type of generative AI being used to a type of generative AI with high accuracy.

As described above, the second example embodiment is characterized in that the generative AI processing unit has a function of switching between the types of generative AI. With this arrangement, for example, in the operation phase of the system, flexible switching can be made between the types of generative AI in consideration of the balance between the answer accuracy, the response speed, and the cost required for the answer.

### Application Examples

Next, the application example of the second example embodiment will be described. An inquiry system of the present example embodiment is applicable to an HS code identification system, similarly to the first example embodiment. The overall configuration of an HS code identification system, the hardware configuration of the information processing device 10x, and the processing flow according to the application example of the second example embodiment are similar to those of the first example embodiment, and thus the description thereof will not be given.

### (Functional Configuration)

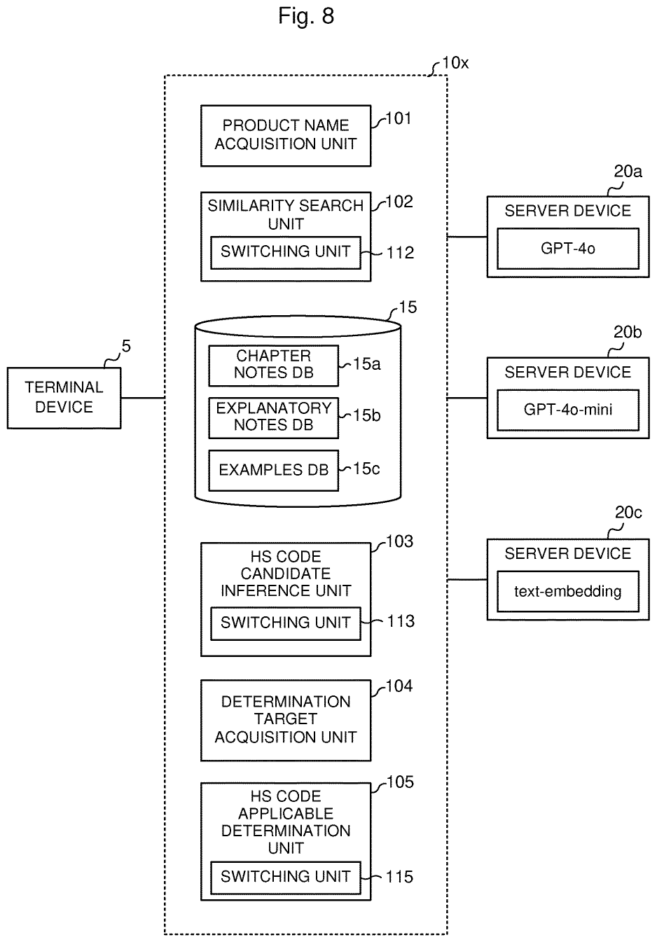

FIG. 8 is a block diagram illustrating the functional configuration of the information processing device 10x according to the application example. As illustrated in FIG. 8, a similarity search unit 102, an HS code candidate inference unit 103, and an HS code applicable determination unit 105, respectively, include a switching unit 112, a switching unit 113, and a switching unit 115 that make a switch between the types of generative AI.

In response to reception of a switching instruction, the switching units 112, 113, and 115 each change a connection destination server device (i.e., a type of generative AI to be used). The switching instruction specifies which generative AI is to be used among the types of generative AI provided by the server devices 20a to 20c. The switching instruction is input by, for example, an administrator of the information processing device 10x. The administrator can provide an instruction to switch between the types of generative AI in consideration of a balance among the answer accuracy, the response speed, and the cost required for the answer while referring to the log of the information processing device 10x.

In the above configuration, the switching units 112, 113, and 115 are exemplary first switching means and second switching means.

According to the second example embodiment, in the system with the combination of the plurality of types of generative AI, a decrease in response speed and an increase in cost can be suppressed while maintaining answer accuracy.

### Third Example Embodiment

Next, a third example embodiment will be described. In the third example embodiment, differences from the first example embodiment and the second example embodiment will be described, and thus the description of similar parts will not be given. In the third example embodiment, the same constituents as those in the first example embodiment and the second example embodiment will be described with the same reference signs.

### [Overall Configuration]

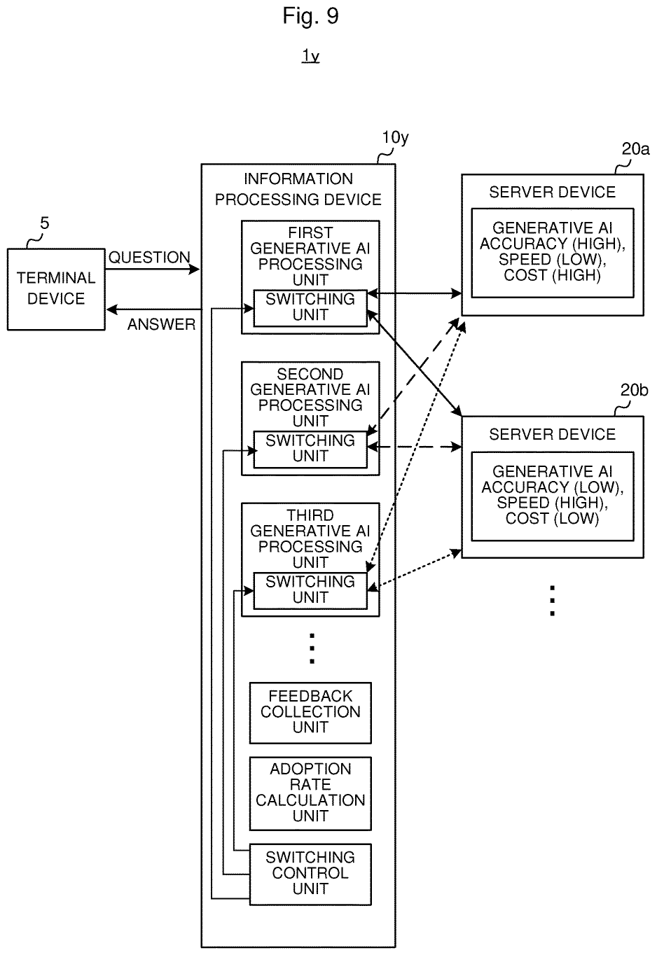

FIG. 9 illustrates the overall configuration of an inquiry system to which an information processing device according to the third example embodiment is applied. An inquiry system 1y includes a terminal device 5, an information processing device 10y, and a plurality of server devices 20.

The information processing device 10y is based on the information processing device 10x according to the second example embodiment, and further includes a feedback collection unit, an adoption rate calculation unit, and a switching control unit.

The feedback collection unit collects feedback from a user on the answer generated by the information processing device 10y. The feedback includes information indicating whether the answer has been adopted. The adoption rate calculation unit calculates the adoption rate of the answer based on the collected feedback. The adoption rate of the answer is calculated, for example, by dividing the number of adopted answers by the number of generated answers.

The switching control unit determines a type of generative AI to be used by each generative AI processing unit based on the adoption rate of the answer. Then, the switching control unit outputs a switching instruction to instruct switching to the determined generative AI to the respective switching units of the generative AI processing units. For example, in a case where the adoption rate of the answer is low, the switching control unit outputs a switching instruction to each switching unit in such a way as to use a type of generative AI with high accuracy provided by the server device 20a. The switching unit changes a connection destination server device (i.e., the type of generative AI to be used) in accordance with the switching instruction.

Here, the information processing device 10y according to the third example embodiment can determine a suitable type of generative AI by performing accuracy comparison while making a switch between the type of generative AI in the test phase of the inquiry system. Specifically, the switching control unit randomly determines a type of generative AI to be used by each generative AI processing unit, and attempts various combinations of types of generative AI. The feedback collection unit collects the feedback at the time of trial. The adoption rate calculation unit calculates the adoption rate of the answer for each of the various combinations of the types of generative AI. Then, the switching control unit determines an optimal combination of types of generative AI based on the adoption rate of the answer and the costs of the types of generative AI. For example, the switching control unit may select a combination of types of generative AI, the costs of which are lowest, as the optimum combination of types of generative AI, from combinations of types of generative AI, the adoption rates of the answer of which are equal to or more than a predetermined threshold TH1. The switching control unit may select a combination of types of generative AI, the adoption rate of the answer of which is highest, from combinations of types of generative AI, the costs of which are equal to or less than a predetermined threshold TH2, as the optimum combination of types of generative AI.

The feedback may include information indicating whether the response speed is slow. The information indicating whether the response speed is slow is collected, for example, by evaluating any of “fast”, “normal”, and “slow” for the time from the transmission of a question to the reception of an answer. The switching control unit determines the generative AI to be used by each generative AI processing unit based on the adoption rate of the answer, the evaluation rate of “slow”, and the cost of the type of generative AI. For example, the switching control unit attempts various combinations of types of generative AI, and determines a combination of types of generative AI, in which its adoption rate is equal to or more than the predetermined threshold TH1, their costs are equal to or less than the predetermined threshold TH2, and its evaluation rate of “slow” is equal to or less than a predetermined threshold TH3, as the optimum combination of types of generative AI.

As described above, the third example embodiment is characterized in that the switching is made between the types of generative AI based on the feedback from the user. With this arrangement, the information processing device 10y can make an automatic switch between the types of generative AI in consideration of the balance between the answer accuracy, the answer speed, and the cost required for the answer.

### Application Examples

The application example of the third example embodiment will be described. The inquiry system of the present example embodiment is applicable to an HS code identification system, similarly to the first example embodiment and the second example embodiment. The overall configuration of the HS code identification system and the hardware configuration of the information processing device 10y according to the application example of the third example embodiment are similar to those of the first example embodiment, and thus the description thereof will not be given.

### (Functional Configuration)

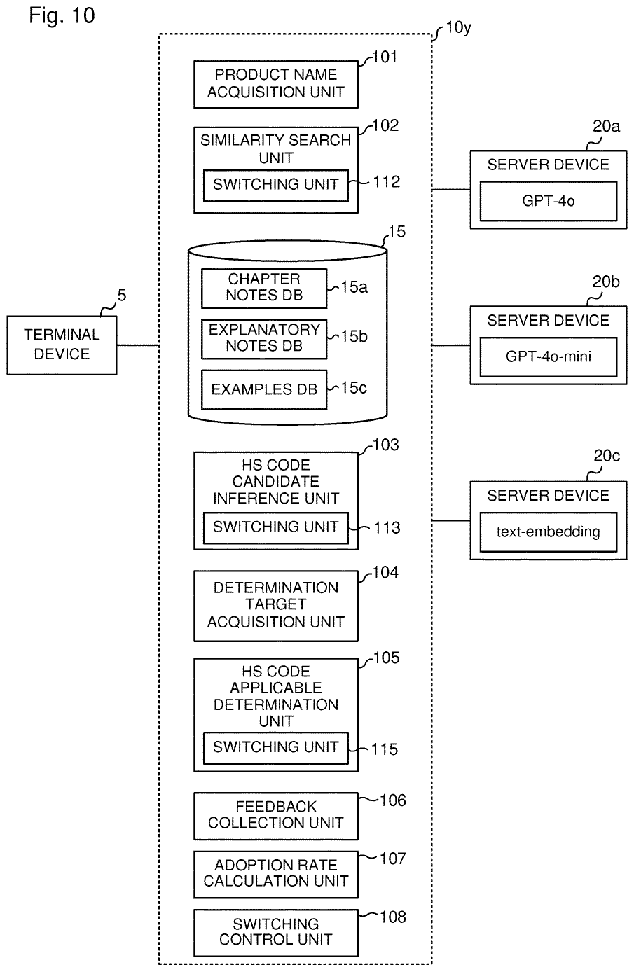

FIG. 10 is a block diagram illustrating the functional configuration of the information processing device 10y according to the application example. As illustrated in FIG. 10, the information processing device 10y further includes a feedback collection unit 106, an adoption rate calculation unit 107, and a switching control unit 108.

In response to reception of the answer (the HS code candidate or the result of the applicable determination) from the information processing device 10y, the user operates the terminal device 5 to perform feedback such as whether to adopt the content of the answer or whether the response speed is slow, and transmits the feedback to the information processing device 10y. The feedback from the user is input into the feedback collection unit 106. The feedback collection unit 106 collects the feedback from the user and outputs the feedback to the adoption rate calculation unit 107.

The adoption rate calculation unit 107 calculates the adoption rate of the answer based on the collected feedback. For example, the adoption rate calculation unit 107 calculates the adoption rate of the answer by dividing the number of answers adopted by the user by the number of answers output by the information processing device 10y. The adoption rate calculation unit 107 calculates the rate of answers evaluated as “slow” (hereinafter, also referred to as the rate of “slow”) among the answers output from the information processing device 10y. The adoption rate calculation unit 107 outputs the adoption rate of the answer and the rate of “slow” to the switching control unit 108.

The switching control unit 108 determines each type of generative AI to be used by each of a similarity search unit 102, an HS code candidate inference unit 103, and an HS code applicable determination unit 105 based on the adoption rate of the answer, the rate of “slow”, and the cost of the type of generative AI. For example, the switching control unit 108 determines each type of generative AI, in which its adoption rate of the answer is equal to or more than the predetermined threshold TH1, its cost is equal to or less than the predetermined threshold TH2, and its rate of “slow” is equal to or less than the predetermined threshold TH3. Then, the switching control unit 108 outputs a switching instruction to switching units 112, 113, and 115. The switching unit 112, 113, and 115 each change a connection destination server device (i.e., a type of generative AI to be used) in accordance with the switching instruction.

In the above configuration, the feedback collection unit 106 is an exemplary feedback collection means, the adoption rate calculation unit 107 is an exemplary adoption rate calculation means, and the switching control unit 108 is an exemplary switching control means.

### (Processing Flow)

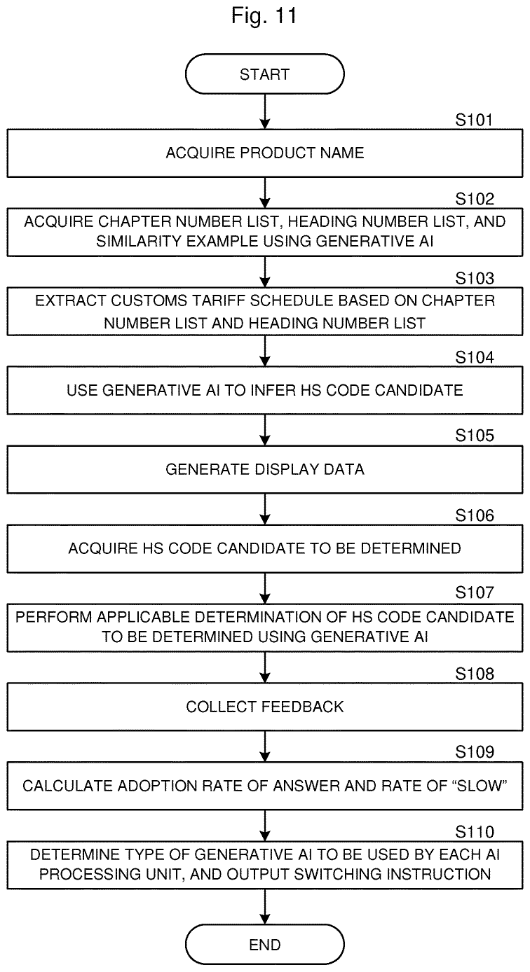

FIG. 11 is a flowchart of HS code identification processing by the information processing device 10y according to the application example. This processing is achieved by such a processor 12 as illustrated in FIG. 4 executing a program prepared in advance and operating as each constituent illustrated in FIG. 10. Note that the processing in steps S101 to S107 is similar to the processing in steps S101 to S107 of the first example embodiment illustrated in FIG. 6, and thus the description thereof will not be given.

In response to reception of the answer from the information processing device 10y, the user operates the terminal device 5, performs feedback on the answer, and transmits the feedback to the information processing device 10y. The feedback includes information such as whether the answer is adopted or whether the response speed is slow.

The feedback from the user is input into the feedback collection unit 106 (step S108). The feedback collection unit 106 collects the feedback from the user and outputs the feedback to the adoption rate calculation unit 107.

The adoption rate calculation unit 107 calculates the adoption rate of the answer and the rate of “slow”, based on the collected feedback (step S109). The adoption rate calculation unit 107 outputs the adoption rate of the answer and the rate of “slow” to the switching control unit 108.

The switching control unit 108 determines a type of generative AI to be used by each of the similarity search unit 102, the HS code candidate inference unit 103, and the HS code applicable determination unit 105, based on the adoption rate of the answer, the rate of “slow”, the cost of the type of generative AI, and outputs a switching instruction to the switching units 112, 113, and 115 (step S110).

The switching unit 112, 113, and 115 each change a connection destination server device (i.e., a type of generative AI to be used) in accordance with the instruction from the switching control unit 108. Then, the processing ends.

According to the third example embodiment, in the system with the combination of the plurality of types of generative AI, a decrease in response speed and an increase in cost can be suppressed while maintaining answer accuracy.

### Fourth Example Embodiment

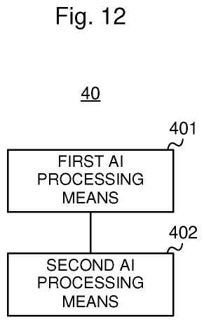

FIG. 12 is a block diagram illustrating the functional configuration of an information processing device according to a fourth example embodiment. An information processing device 40 includes a first AI processing means 401 and a second AI processing means 402.

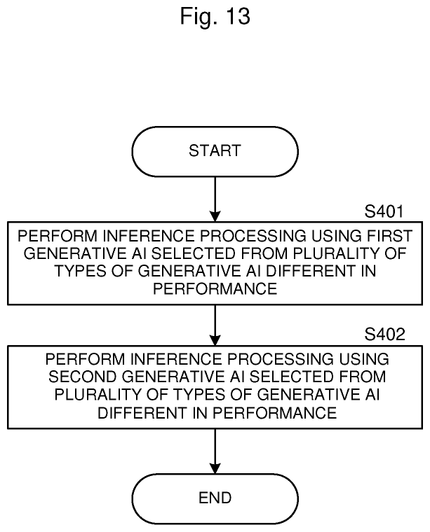

FIG. 13 is a flowchart of processing by the information processing device according to the fourth example embodiment. The first AI processing means 401 performs inference processing using first generative AI selected from a plurality of types of generative AI different in performance (step S401). The second AI processing means 402 executes inference processing using second generative AI selected from a plurality of types of generative AI different in performance (step S402). Here, the performance includes answer accuracy, response speed, and cost. The first generative AI is selected based on the content of the inference processing performed by the first AI processing means and the performance, and the second generative AI is selected based on the content of the inference processing performed by the second AI processing means and the performance.

According to the information processing device 40 of the fourth example embodiment, in a system with a combination of the plurality of types of generative AI, a decrease in response speed and an increase in cost can be suppressed while maintaining the answer accuracy.

Some or all of the above example embodiments may also be described as the following supplementary notes, but are not limited to the following.

### (Supplementary Note 1)

An information processing device including:
a first AI processing means for performing inference processing using first generative AI selected from a plurality of types of generative AI different in performance including answer accuracy, response speed, and cost; and
a second AI processing means for performing inference processing using second generative AI selected from a plurality of types of generative AI different in performance including answer accuracy, response speed, and cost, in which
the first generative AI is selected based on content of the inference processing to be performed by the first AI processing means and the performance, and the second generative AI is selected based on content of the inference processing to be performed by the second AI processing means and the performance.

### (Supplementary Note 2)

The information processing device according to Supplementary Note 1, further including:
a first switching means for making a switch to a type of generative AI to be used by the first AI processing means;
a second switching means for making a switch to a type of generative AI to be used by the second AI processing means; and
a switching control means for instructing each of the first switching means and the second switching means to make a switch to a type of generative AI.

### (Supplementary Note 3)

The information processing device according to Supplementary Note 2, in which the switching control means determines the type of generative AI to be used by each of the first AI processing means and the second AI processing means based on feedback from a user.

### (Supplementary Note 4)

The information processing device according to Supplementary Note 3, further including:
an acquisition means for acquiring a question from the user through a terminal device; and
an output means for outputting an answer to the question, in which
the first AI processing means performs the first inference processing on the question,
the second AI processing means performs the second inference processing on the question based on a result of the first inference processing, and
the output means outputs a result of the second inference processing to the terminal device.

### (Supplementary Note 5)

The information processing device according to Supplementary Note 3, further including:
an acquisition means for acquiring a question from the user through a terminal device; and
an output means for outputting an answer to the question, in which
the first AI processing means performs the first inference processing on the question,
the second AI processing means performs the second inference processing on the question, and
the output means generates the answer based on a result of the first inference processing and a result of the second inference processing, and outputs the answer to the terminal device.

### (Supplementary Note 6)

The information processing device according to Supplementary Note 4 or 5, further including:
a feedback collection means for collecting feedback from the user to an answer from the information processing device;
an adoption rate calculation means for calculating an adoption rate of the answer based on the feedback, in which
the feedback includes information indicating whether the answer from the information processing device has been adopted, and
in a case where the adoption rate is less than a first threshold, the switching control means provides an instruction in such a way that a switch is made to a type of generative AI, the answer accuracy of which is high.

### (Supplementary Note 7)

The information processing device according to Supplementary Note 6, in which
the feedback collection means collects feedback from the user regarding various combinations of types of generative AI used as the first generative AI and types of generative AI used as the second generative AI, and
the switching control means selects a combination of types of generative AI, the costs of which are lowest, from combinations of types of generative AI, the adoption rates of which are equal to or more than the first threshold, as a combination of a type of generative AI to be used by the first AI processing means and a type of generative AI to be used by the second AI processing AI, or selects a combination of types of generative AI, the adoption rate of which is highest, from combinations of types of generative AI, the costs of which are equal to or less than the second threshold, as a combination of a type of generative AI to be used by the first AI processing means and a type of generative AI used by the second AI processing means.

### (Supplementary Note 8)

The information processing device according to Supplementary Note 6, in which
the feedback includes information indicating whether the response speed of the information processing device is slow,
the adoption rate calculation means calculates a rate of answers evaluated as slow among answers output from the information processing device, and
the switching control means determines a combination of a type of generative AI to be used by the first AI processing means and a type of generative AI to be used by the second AI processing means based on the adoption rate, the rate of the answers evaluated, and the cost.

### (Supplementary Note 9)

An information processing method to be performed by a computer including:
performing first AI processing inference processing using first generative AI selected from a plurality of types of generative AI different in performance including answer accuracy, response speed, and cost; and
performing second AI processing inference processing using second generative AI selected from a plurality of types of generative AI different in performance including answer accuracy, response speed, and cost, in which
the first generative AI is selected based on content of the inference processing to be performed by the first AI processing and the performance, and the second generative AI is selected based on content of the inference processing to be performed by the second AI processing and the performance.

### (Supplementary Note 10)

A program for causing a computer to perform processing including:
performing first AI processing including inference processing using first generative AI selected from a plurality of types of generative AI different in performance including answer accuracy, response speed, and cost; and
performing second AI processing including inference processing using second generative AI selected from a plurality of types of generative AI different in performance including answer accuracy, response speed, and cost, in which
the first generative AI is selected based on content of the inference processing to be performed by the first AI processing and the performance, and the second generative AI is selected based on content of the inference processing to be performed by the second AI processing and the performance.

While the present disclosure has been particularly shown and described with reference to the example embodiments and examples thereof, the present disclosure is not limited to these example embodiments and examples and examples. It will be understood by those of ordinary skill in the art that various changes in form and details may be made therein without departing from the spirit and scope of the present disclosure as defined by the claims.

### DESCRIPTION OF SYMBOLS

1,1x,1y inquiry system
2 HS code identification system
5 terminal device
10,10x,10y information processing device
15 database (DB)
101 product name acquisition unit
102 similarity search unit
103 HS code candidate inference unit
104 determination target acquisition unit
105 HS code applicable determination unit
15a chapter notes DB
15b explanatory notes DB
15c examples DB
106 feedback collection unit
107 adoption rate calculation unit
108 switching control unit

1. An information processing device comprising:
at least one memory configured to store instructions; and
at least one processor configured to execute the instructions to:
perform first inference processing using first generative AI selected from a plurality of types of generative AI different in performance including answer accuracy, response speed, and cost; and
perform second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.

2. The information processing device according to claim 1, the one or more processors are further configured to switch a type of generative AI to be used as the first generative AI from among a plurality of types of generative AI, and switch a type of generative AI to be used as the second generative AI from among the plurality of types of generative AI.

3. The information processing device according to claim 2, wherein the one or more processors determine the type of generative AI based on feedback from a user.

4. The information processing device according to claim 3, the one or more processors are further configured to acquire a question from the user through a terminal device, and
output an answer to the question, wherein
the one or more processors perform the first inference processing on the question,
the one or more processors perform the second inference processing on the question based on a result of the first inference processing, and
the one or more processors output a result of the second inference processing to the terminal device.

5. The information processing device according to claim 3, the one or more processors are further configured to acquire a question from the user through a terminal device, and
output an answer to the question, wherein the one or more processors perform the first inference processing on the question,
the one or more processors perform the second inference processing on the question, and
the one or more processors generate the answer based on a result of the first inference processing and a result of the second inference processing, and outputs the answer to the terminal device.

6. The information processing device according to claim 4, the one or more processors are further configured to collect feedback from the user to an answer from the information processing device, and
calculate an adoption rate of the answer based on the feedback, wherein
the feedback includes information indicating whether the answer from the information processing device has been adopted, and
in a case where the adoption rate is less than a first threshold, the one or more processors provide an instruction in such a way that a switch is made to a type of generative AI, the answer accuracy of which is high.

7. The information processing device according to claim 6, wherein
the one or more processors collect feedback from the user regarding various combinations of types of generative AI used as the first generative AI and types of generative AI used as the second generative AI, and
the one or more processors select a combination of types of generative AI, the costs of which are lowest, from combinations of types of generative AI, the adoption rates of which are equal to or more than the first threshold, as a combination of a type of generative AI to be used by the first inference processing and a type of generative AI to be used by the second inference processing,
or select a combination of types of generative AI, the adoption rate of which is highest, from combinations of types of generative AI, the costs of which are equal to or less than a second threshold, as a combination of a type of generative AI to be used by the first inference processing and a type of generative AI used by the second inference processing.

8. The information processing device according to claim 6, wherein
the feedback includes information indicating whether the response speed of the information processing device is slow,
the one or more processors calculate a rate of answers evaluated as slow among answers output from the information processing device, and
the one or more processors determine a combination of a type of generative AI to be used by the first inference processing and a type of generative AI to be used by the second inference processing based on the adoption rate, the rate of the answers evaluated, and the cost.

9. An information processing method to be performed by a computer comprising:
performing first inference processing using first generative AI selected from a plurality of types of generative AI different in performance including answer accuracy, response speed, and cost; and
performing second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.

10. A non-transitory computer readable recording medium recording a program for causing a computer to execute processing comprising:
performing first inference processing using first generative AI selected from a plurality of types of generative AI different in performance including answer accuracy, response speed, and cost; and
performing second inference processing using second generative AI selected from a plurality of types of generative AI different in performance including answer accuracy, response speed, and cost, wherein
the first generative AI is selected based on content of the first inference processing and the performance, and the second generative AI is selected based on content of the second inference processing and the performance.
